(19) United States
(12) Patent Application Publication
(10) Pub. No.: US 2017/0288253 A1
(43) Pub. Date: Oct. 5, 2017

(54) Thermoelectrochemical Heat Converter

(71) Applicant: The Board of Trustees of the Leland Stanford Junior University, Palo Alto, CA (US)

(72) Inventors: William C. Chueh, Menlo Park, CA (US); Andrey D. Poletayev, Stanford, CA (US); Ian S. McKay, Palo Alto, CA (US); Arunava Majumdar, Menlo Park, CA (US)

(21) Appl. No.: 15/473,452

(22) Filed: Mar. 29, 2017

Related U.S. Application Data
(60) Provisional application No. 62/314,856, filed on Mar. 29, 2016.

(51) Int. Cl. H01M 8/18; H01M 4/86; H01M 8/20

(52) U.S. Cl. CPC H01M 8/182; H01M 8/20; H01M 4/8605

(57) ABSTRACT

A direct thermoelectrochemical heat-to-electricity converter includes two electrochemical cells at hot and cold temperatures, each having a gas-impermeable, electron-blocking membrane capable of transporting an ion I, and a pair of electrodes on opposite sides of the membrane. Two closed-circuit chambers A and B each includes a working fluid, a pump, and a counter-flow heat exchanger. The chambers are connected to opposite sides of the electrochemical cells and carry their respective working fluids between the two cells. The working fluids are each capable of undergoing a reversible redox half-reaction of the general form R→O+I+e⁻, where R is a reduced form of an active species in a working fluid and O is the oxidized forms of the active species. One of the first pair of electrodes is electrically connected to one the second pair of electrodes via an electrical load to produce electricity. The device thereby operates such that the first electrochemical cell runs a forward redox reaction, gaining entropy, and the second electrochemical cell runs a reverse redox reaction, expelling entropy.

### CROSS-REFERENCE TO RELATED APPLICATIONS

This application claims priority from U.S. Provisional Patent Application 62/314,856 filed Mar. 29, 2016, which is incorporated herein by reference.

### FIELD OF THE INVENTION

The present invention relates generally to devices and techniques that convert the heat energy stored in the entropy of a hot gas into electrical work, without mechanical motion.

### BACKGROUND OF THE INVENTION

Almost 90% of the world's primary energy consumption occurs through the use of heat, and approximately 60% of this thermal energy is lost as rejected waste heat. Given the large magnitude of energy in waste heat, its efficient conversion to electrical power offers a significant opportunity to lower greenhouse gas emissions across the energy sector, transportation, and manufacturing. However, it has been difficult to optimize the performance of new direct energy conversion approaches because of the inability to decouple entropy change from thermal and electrical transport in materials and continuously operating devices.

Thermoelectric (TE) heat engines are widely considered to be the most promising candidates for converting distributed heat sources to electricity, with their electrochemical analogues, thermogalvanic (TG) heat engines, also receiving attention. For both, the inability to completely decouple carrier entropy (thermopower α), heat transport (thermal conductivity κ) and charge transport (electrical resistivity ρ) in a single material has so far kept efficiencies well below those of traditional thermofluid cycles. Alternatively, thermally regenerative electrochemical cycles separate charge and heat transport in the time domain, but only produce electricity intermittently. Electrochemical sodium heat engines, which have demonstrated high efficiency and reasonable scalability, have stringent temperature requirements and stability issues. Thus, it remains an unsolved challenge in direct heat-to-electricity conversion to realize continuous thermodynamic cycles that completely decouple entropy, heat and charge transport and operate across a broad range of temperatures.

### BRIEF SUMMARY OF THE INVENTION

In one aspect, the present invention provides a thermoelectrochemical heat converter that generates electrical power from hot gases without mechanical motion. In operation, gas flows through solid-state ion-conducting membranes and generates current across an external load. A pump is not necessary to maintain operational pressures. Multiple membrane assemblies can be connected in series and in parallel to control the current and voltage output of the device.

The device is the first to directly convert the entropy of a hot gas to electrical work without the need of overpressures. The device can be operated as an open system with net flow of gas, or as a closed-loop system with recirculation. In the open-system case, an external pump is not necessary to maintain operational pressures. The device offers potential improvements in heat conversion efficiency, temperature range, and power per unit weight over a thermoelectric.

In one aspect, a device according to an embodiment of the invention includes two ion-transporting, gas-impermeable, and electron-blocking membranes, one at the hot side, and one at the cold side. Each membrane is contacted on both sides by porous electrodes connected to external loads.

In some embodiments, membranes can be connected in series or in parallel to increase voltage or current output, respectively. A pump can be attached to recirculate gas in the system. The device can be connected with others, such as thermoelectric generators, for more efficient use of waste heat.

The heat converters according to the invention have many applications, including directly generating electrical power from hot gases or waste heat without mechanical motion, separating mixtures of gases, purifying hot gases, scrubbing carbon dioxide from smoke or exhaust, converting solar heat energy to electrical work.

In one aspect, the invention provides a device for direct thermoelectrochemical heat-to-electricity conversion. The device includes a first electrochemical cell having a first gas-impermeable, electron-blocking membrane capable of transporting an ion I at a first temperature, and a first pair of electrodes on opposite sides of the first membrane; and a second electrochemical cell having a second gas-impermeable, electron-blocking membrane capable of transporting the ion I at a second temperature lower than the first temperature, and a second pair of electrodes on opposite sides of the second membrane. The device also includes a closed-circuit chamber A having a working fluid A, a pump A, and a counter-flow heat exchanger A, wherein the closed-circuit chamber A is connected to the first electrochemical cell on a side A of the first membrane and to the second electrochemical cell on a side A of the second membrane; and a closed-circuit chamber B comprising a working fluid B, a pump B, and a counter-flow heat exchanger B, wherein the closed-circuit chamber B is connected to the first electrochemical cell on a side B of the first membrane and to the second electrochemical cell on a side B of the second membrane. The working fluid A is capable of undergoing a reversible redox half-reaction of the general form R_{A}→O_{A}+I+e⁻ and wherein the working fluid B is capable of undergoing a reversible redox half-reaction of the general form R_{B}→O_{B}+I+e⁻, where R_{A} and R_{B} are reduced forms of active species in working fluid A and working fluid B, respectively, O_{A} and O_{B} are the oxidized forms of active species in working fluid A and working fluid B, respectively. The first electrochemical cell is connected electrically in series with the second electrochemical cell. One of the first pair of electrodes is porous to the working fluid A, and another one of the first pair of electrodes is porous to the working fluid B. Similarly, one of the second pair of electrodes is porous to the working fluid A, and another one of the second pair of electrodes is porous to the working fluid B. One of the first pair of electrodes is electrically connected to one the second pair of electrodes via an electrical load to produce electricity. The device thereby operates such that the first electrochemical cell runs a forward redox reaction, gaining entropy, and the second electrochemical cell runs a reverse redox reaction, expelling entropy.

### BRIEF DESCRIPTION OF THE SEVERAL VIEWS OF THE DRAWINGS

FIGS. 1A-E are diagrams illustrating the principle of operation of a continuous electrochemical heat engine according to an embodiment of the invention.

FIGS. 2A-F illustrate two electrochemical heat engines according to embodiments of the invention.

FIGS. 3A-F illustrate results of simulations of continuous electrochemical heat engines.

FIG. 4 shows the effect of jet-impingement fluid circulation on the polarization profile of the V^{2+/3+}∥Fe(CN)₆^{3-/4-} energy harvesting system illustrating different temperature-dependencies of kinetic and transport-based overpotentials.

FIG. 5 shows a gas-based electrochemical heat engine. The two-cell experimental setup harvests heat with solid-oxide fuel cells. Oxygen-transporting membranes 500, 502 at T_{H} and T_{C}, respectively, are connected electrically in series.

FIGS. 6A-B are graphs of power output and efficiency as functions of R_{Ω} and j₀₀ of the cold cell for a gas-phase electrochemical heat. The reference values on the axes are given at 500° C. The parameters of the hot cell are not changed.

FIG. 7 illustrates an experimental cell for liquid-phase energy harvesting. The membrane electrode assembly flow cell used for liquid phase energy harvesting shown in cross sectional view. Carbon paper electrodes with Pt/C catalyst coating were used as the positive electrode.

FIG. 8 illustrates a 2-channel counterflow heat exchanger in cross-sectional view.

FIG. 9 illustrates a liquid-based continuous electrochemical energy harvesting system. “WE”, “REF”, and “CE” are the working, reference, and counter electrode connections to the potentiostat, respectively.

FIGS. 10A-C illustrate the results of simulations of the liquid-based heat engine. FIG. 10A is a graph of efficiency vs. output power density for a liquid-based electrochemical heat engine operating between 50° C. and 10° C., with heat exchanger UA 20, 50, 100, 200, and 400 kW K⁻¹, operating on electrolytes with total α=3 mV/K and concentrations 3M and 0.75M. FIG. 10B is a plot of power output, and FIG. 10C is a plot of efficiency as functions of T_{H} and T_{C} for a liquid-phase electrochemical heat engine with α=3 mV K⁻¹ and k₀=10-3 cm sec⁻¹ and heat exchanger thermal conductivity 400 kW K⁻¹.

### DETAILED DESCRIPTION OF THE INVENTION

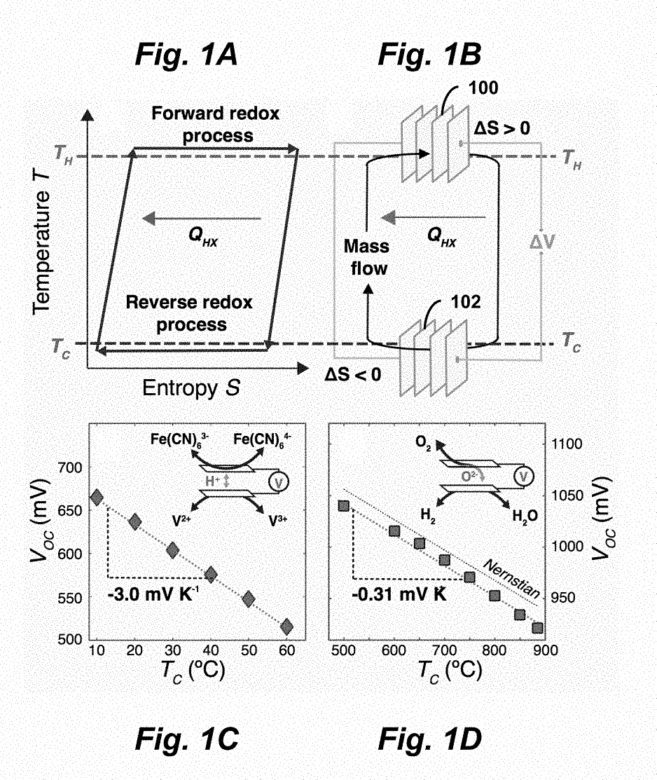

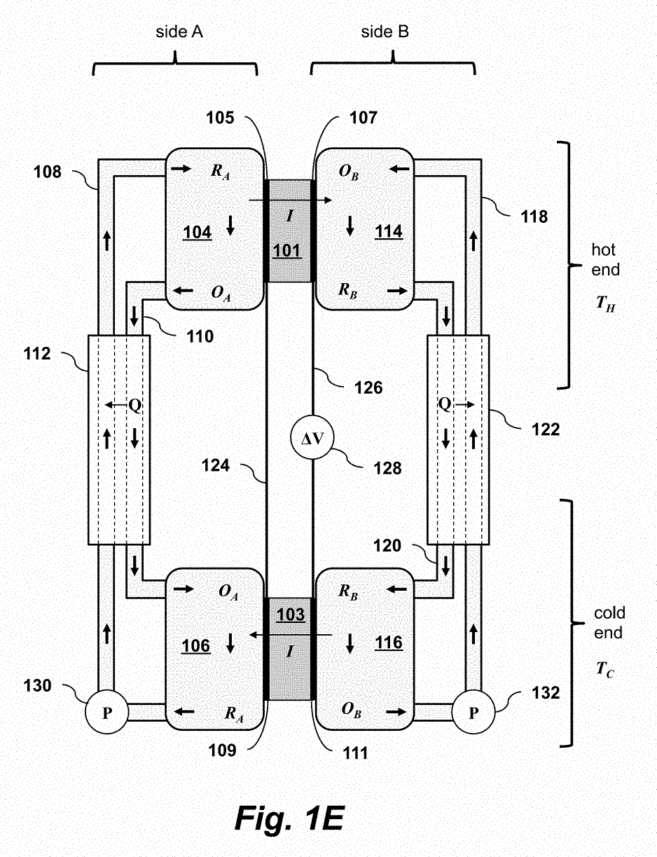

Embodiments of the present invention provide continuous electrochemical heat engines based on two redox-active working fluids separated by ion-selective membranes. As shown in FIGS. 1A-B, a first electrochemical cell 100 runs a forward redox reaction at a hot temperature T_{H}, gaining entropy, and a second cell 102 simultaneously runs the reverse process at a cold temperature T_{C}, expelling entropy. Counterflow heat exchange between the reduced and oxidized fluid streams decreases irreversible heat loss between hot and cold temperature reservoirs. This technique allows for the independent optimization of entropic, electrical, and thermal processes: whereas the redox reactions determine α, the ion-selective membranes determine ρ, and a heat exchanger between the two fluids sets an effective κ. The stability and kinetics of the redox fluid and the electrochemical cell set the cycle temperature, which can range from well below room temperature to 1000° C. Unlike in TE or TG systems, cells can be connected in series at each temperature, allowing the power of the system to scale independently from heat leaks across the device, while the requisite mass flow between the hot and cold junctions can be supplied by either active or passive circulation.

FIGS. 1A-D are diagrams illustrating the principle of operation of a continuous electrochemical heat engine according to an embodiment of the invention. FIG. 1A is a temperature-entropy graph of the process, and FIG. 1B is a system diagram. Two stacks of electrochemical cells 100, 102 are connected in series, one immersed in a hot thermal reservoir at temperature T_{H}, and the other immersed in a cold thermal reservoir at temperature T_{C}. The entropy of the electrochemical redox reactions yields a potential difference ΔV across the two stacks of electrochemical cells. The recuperative heat exchange between the two electrolyte streams is shown as Q_{HX}. FIG. 1C is a graph of measured open-circuit potential (V_{OC}) as a function of temperature for low-temperature liquid-electrolyte cells. A cell has V^{2+/3+} and Fe(CN)₆^{3-/4-} liquid electrolytes with proton exchange through a Nafion membrane. Error bars based on the standard deviation between three sequential measurements are smaller than the marker size. FIG. 1D is a graph of measured open-circuit potential (V_{OC}) as a function of temperature for high temperature gaseous cells. This embodiment uses the water splitting redox reaction producing H₂ and O₂ with O²⁻ exchange through an oxygen transport membrane using 5% H₂ humidified to pH₂O˜0.028 atm versus 21% O₂. The error bars, calculated as the deviation of voltage over 30 min, are smaller than the marker size. The black dotted line shows V_{OC} calculated from thermochemical data with the Nernst equation. In both cases, the slope of the line is equivalent to the total thermopower α₁-α₂.

FIG. 1E is a schematic diagram of a device for direct thermoelectrochemical heat-to-electricity conversion according to an embodiment of the invention. The device includes a first electrochemical cell having a first gas-impermeable, electron-blocking membrane 101 capable of transporting an ion I at a first temperature, and a first pair of electrodes 105, 107 on opposite sides of the first membrane; and a second electrochemical cell having a second gas-impermeable, electron-blocking membrane 103 capable of transporting the ion I at a second temperature lower than the first temperature, and a second pair of electrodes 109, 111 on opposite sides of the second membrane. The device also includes a closed-circuit chamber A with a hot end 104, cold end 106, and two conduits 108, 110 connecting them to form a cycle. The chamber A contains a working fluid A that circulates between hot and cold ends. It also contains a pump 130, and a counter-flow heat exchanger 112, where the conduits allow the working fluid A to exchange heat in counter-current flow between hot and cold ends. The closed-circuit chamber A is connected to the first electrochemical cell on a side A of the first membrane 101 and to the second electrochemical cell on a side A of the second membrane 103. Similarly, the device includes a closed-circuit chamber B which includes hot end 114, cold end 116 and conduits 118 and 120, for cycling a working fluid B. It also includes a pump 132, and a counter-flow heat exchanger 122. The closed-circuit chamber B is connected to the first electrochemical cell on a side B of the first membrane 101 and to the second electrochemical cell on a side B of the second membrane 103. The first electrochemical cell is connected electrically in series with the second electrochemical cell with conducting wires 124, 126, attached to their electrodes 105, 107, 109, 111. Electrodes 105 and 109 are porous to the working fluid A, and electrodes 107, 111 are porous to the working fluid B. Electrodes 107, 111 are connected via an electrical load 128 to produce electricity. The working fluid A circulating in closed-circuit chamber A is capable of undergoing a reversible redox half-reaction of the general form R_{A}→O_{A}+I+e⁻. Similarly, the working fluid B circulating in close-circuit chamber B is capable of undergoing a reversible redox half-reaction of the general form R_{B}→O_{B}+I+e⁻, where R_{A} and R_{B} are reduced forms of active species in working fluid A and working fluid B, respectively, O_{A} and O_{B} are the oxidized forms of active species in working fluid A and working fluid B, respectively. The device thereby operates such that the first electrochemical cell runs a forward redox reaction, gaining entropy, and the second electrochemical cell runs a reverse redox reaction, expelling entropy.

The working fluids may be, for example, oxygen, hydrogen, water, carbon monoxide, carbon dioxide, or mixtures thereof. More generally, the working fluids may be liquids, gases, dissolved species or slurries, supporting redox processes with different entropies of reduction and containing a species that crosses the ion-transporting membrane as the ion I. The species that undergo redox reactions within the working fluids are distinct from the atom or ion that traverses the ion-conducting membrane; e.g. while the redox-active species could be complexes of transition metals undergoing outer-sphere electron transfer, the ion crossing the membrane (such as a proton, or a hydroxide, or others) does not have to participate in those reactions. Examples of working fluids are: (a) an aqueous or non-aqueous solution of redox couples, with supporting ions such as H⁺, OFF, Cl⁻, or others crossing the cell membranes. Redox couples could be complexes of transition metals (Fe, Cu, V, Co, or others), organic molecules (quinones, pyridines or others), polyelectrolytes, or some others. (b) Slurries of redox-active solid materials (such as lithium iron phosphate LiₓFePO₄, lithium titanate, or others) and supporting ions, such as Li⁺ or others, (c) molten phases, e.g. metals, (d) gaseous phases as described below.

The first membrane or second membrane may be an ion-conducting ceramic, an ion-conducting polymer, or a molten salt. Examples include: yttria-stabilized zirconia (YSZ) or doped ceria (CeO2) for oxygen gas (as O²⁻ in the membrane), yttrium-doped barium zirconates (BYZ) for hydrogen or water vapour (as H⁺ or OH⁻ in the membrane), a molten carbonate salt (NaCO3, LiCO3, KCO3, their mixtures, or others) on porous (LiAlO2, beta-alumina, or others) support for CO and CO2 (as CO₃²⁻ in the membrane). Further examples include: (a) beta- or beta”-alumina, other ion-conducting ceramics, or molten salts, for Na⁺, K⁺, or other metal ions crossing the membrane, (b) ion-conducting polymers, such as Nafion, PET or others for protons or hydroxide ions crossing in liquid solvents.

The porous electrodes may be alloys of W, Mo, Ni, other metals, or ceramics that could further be supported on an electronically conducting or mixed ion-electron-conducting framework, e.g., Pt on carbon cloth.

In some embodiments, the first and/or second electrochemical cell may include multiple electrochemical cells connected in series.

The principles of the present invention are highly generalizable: a wide range of species, including liquids, gases, dissolved species and slurries, supporting redox processes with different entropies of reduction, ΔS, can serve as the working fluids. Expressed per coulomb of charge transferred, ΔS manifests as the electrochemical thermopower α; the difference of the thermopowers in the two reactions α₁-α₂ determines the open-circuit voltage (OCV) output of the device as ΔV_{OC}=|(α₁-α₂) ΔT|, where ΔT=(T_{H}−T_{C}). Table 1 lists the thermopower of individual liquid redox couples measured experimentally in this work, which allow for combined α₁-α₂ in excess of −3 mV K⁻¹ (also shown in FIG. 1C). Clearly, both the working fluids and system design for electrochemical heat engines represent vast and largely unexplored parameter spaces.

TABLE 1
Measured entropy change per coulomb of faradaic charge transfer
α = dE/dT = ΔS/nF, for candidate redox couples.
Since the device thermopower is the difference α₁ − α₂ between
the thermopower of two working fluids, the total thermopower can
exceed 3 mV K⁻¹.

| Redox Couple | α (mV K⁻¹) |
|---|---|
| Fe(CN)₆^{3-/4-} | −1.4 |
| Benzoquinone/Hydroquinone | −1.1 |
| HBr/Br2 | 0.2 |
| Methyl viologen (2+/1+) | 0.6 |
| Fe^{2+/3+} | 1.1 |
| V^{2+/3+} | 1.7 |

Embodiments of the invention include two types of continuous electrochemical heat engines that operate at room temperature and up to ˜900° C., respectively. The ability to fully decouple entropy conversion, thermal transport, and electrical transport enables system efficiencies over 30% of the Carnot limit. Simulations suggest even higher performance at maximum power in scaled systems, making continuous electrochemical heat engines a promising new approach.

For the low-temperature embodiment, the aqueous V^{2+/3+}∥Fe(CN)₆^{3-/4-} couples were chosen on the merits of their high charge capacity, facile redox behavior, and large α₁-α₂. For the high-temperature system, oxygen gas was used as an entropy carrier via the H₂/H₂O∥O₂ couples, mediated by solid-oxide electrochemical cells. FIG. 1C-D illustrates the dependence of cell potentials on temperature in the two systems.

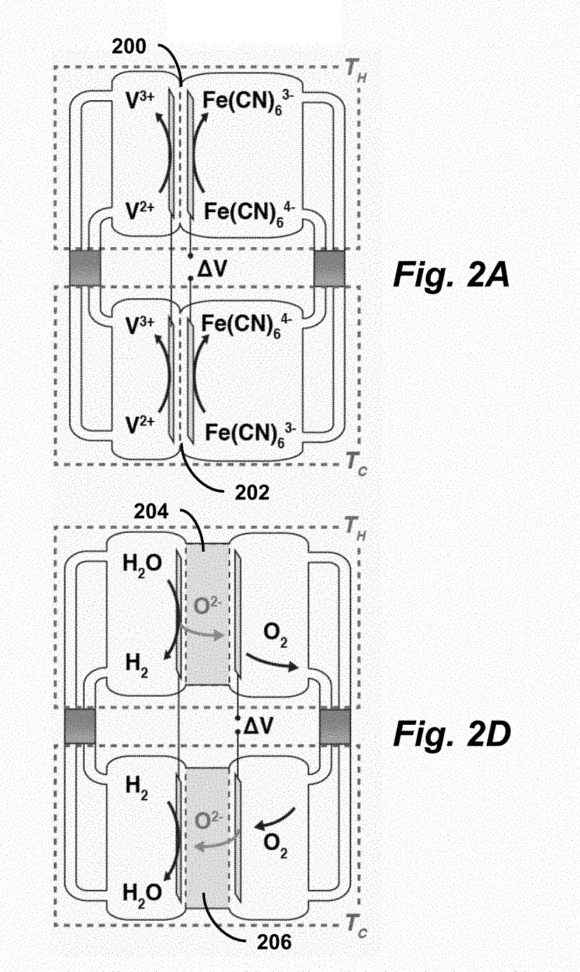

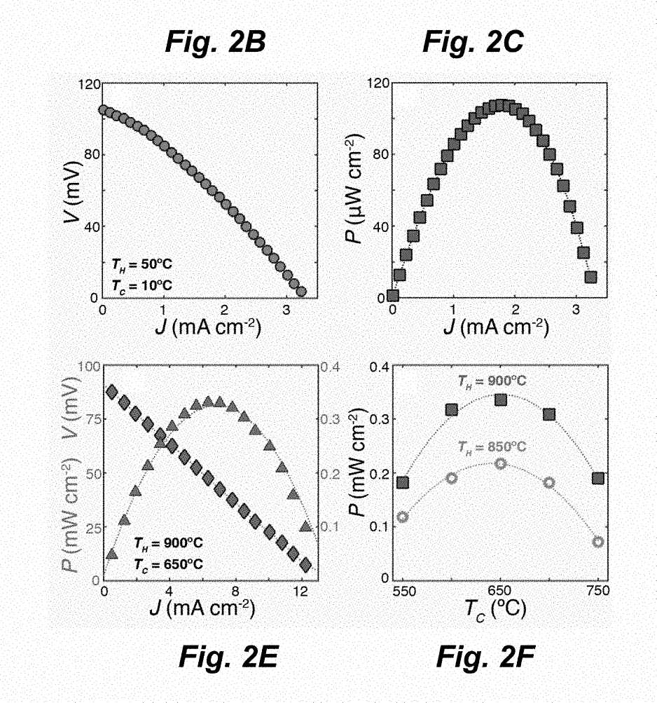

FIG. 2A is a schematic of the low-temperature continuous electrochemical energy harvester embodiment, which is based on heat-exchanged flow of electrolyte between two V^{2+/3+}∥Fe(CN)₆^{3-/4-} cells 200, 202. Peristaltic pumps used for electrolyte circulation are not shown for clarity. FIG. 2B is a polarization curve for the two V^{2+/3+}∥Fe(CN)₆^{3-/4-} cells 200, 202 maintained at a ΔT=40° C., which T_{H}=50° C. and T_{C}=10° C. The curve shows the voltage generated across the two cells as a function of the current density flowing between the cells. The polarization curve yields an OCV of 108 mV and a maximum power density of 110 μW/cm² at a voltage of 60 mV (FIG. 2c). Neglecting heat loss to the ambient, we measure an efficiency as high as 0.34 η_{c}, and η=0.15η_{c} at the maximum power point, where the Carnot efficiency η_{c}=(T_{H}−T_{C})/T_{H}=12.4%. Since the electrolyte flow rate in both anolyte and catholyte were matched to the reaction rate in the small cells, the total flow rate was low, limiting the effectiveness of the heat exchanger and leaving room for improvement in system performance. While individual dV_{OC}/dT values of low-concentration V^{2+/3+} and Fe(CN)₆^{3-/4-} yield a thermopower as high as 3 mV/K, concentration effects lower the effective thermopower to 2.6 mV/K. FIG. 2C is a power curve produced from the polarization data in FIG. 2B.

FIG. 2D is a schematic of a high-temperature electrochemical heat engine embodiment, which uses oxygen as the working fluid between cells 204 and 206. The cells are two anode-supported Ni-YSZ/YSZ/(La,Sr)MnO₃₋ₓ button cells (YSZ=yttria-stabilized zirconia) carrying out the water splitting reaction at T_{H} and the hydrogen combustion reaction at T_{C} in a two-zone vertical furnace. The heat engine preferably incorporates heat exchange, and continuously circulates both gases through the cells. FIG. 2E shows a power and polarization characteristic of the high-temperature heat engine using 5% H₂ humidified to pH₂O˜0.028 atm versus 21% O₂, with T_{H}=900° C., T_{C}=650° C. FIG. 2F is a graph of maximum power of the high temperature system as a function of T_{C} between 550° C. and 750° C., for T_{H}=850° C. (green) and 900° C. (blue).

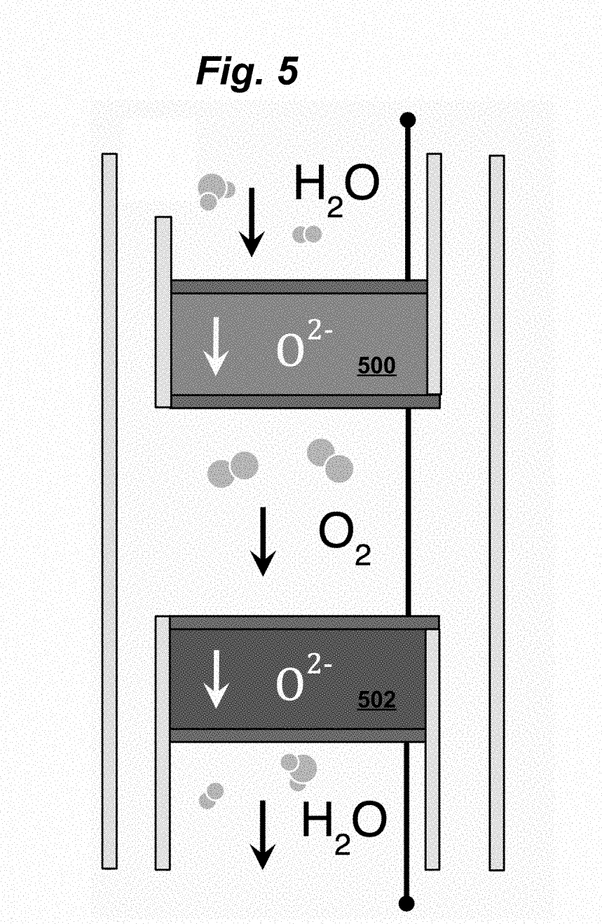

FIG. 2E shows the polarization curve and the resulting output power at T_{H}=900° C. and T_{C}=650° C., and FIG. 2F shows the maximum power densities as a function of T_{C} and T_{H} between 550° C. and 750° C., for T_{H}=850° C. and 900° C. For T_{H}=900° C., we obtained an OCV of 90 mV and a maximum power density of 0.32 mW cm⁻² at a voltage of 50 mV. As expected, the resistance of the cold cell limits the power density for low T_{C}, and OCV limits power for smaller ΔT. We did not attempt to close the mass flow, instead exhausting the gases as they exited the chambers. Further details on the high-temperature energy harvesting system are given in FIG. 5.

The high and low temperature embodiments are examples that represent select points in the wide space open to the materials and system design of continuous electrochemical heat engines. To further explore this parameter space, we developed a modeling framework to estimate the practical performance of continuous electrochemical heat engines. Based on a simple device configuration, the overall heat engine efficiency is given as:

$$η = \frac{I ( I Δ {V}_{OC} - IR ) - {I}^{2} {R}_{L} - {P}_{aux}}{{IT}_{H} ( {α}_{1} - {α}_{2} ) + {Q}_{L} + ( 1 - {ɛ}_{HX} ) \dot{m} {c}_{p} Δ T} \qquad ( 1 )$$

where R_{L} is the resistance loss in the leads and Pₐᵤₓ is any auxiliary power input, such as a pump driving circulation. The thermodynamic heat input is I T_{H} (α₁-α₂), Q_{L} reflects all conductive leaks in the system and heat leaks from the mass transport of reactants are (1−ε_{HX}) \dot{m} cₚ ΔT, where ε_{HX} is the effectiveness of the recuperative heat exchanger. The simulation includes mass transport and solution resistance as well as conductive heat leaks along the current collecting leads and along the length of a counter-flow heat exchanger. The relevant performance metrics for continuous electrochemical heat engines are the maximum power and efficiency at the maximum power point.

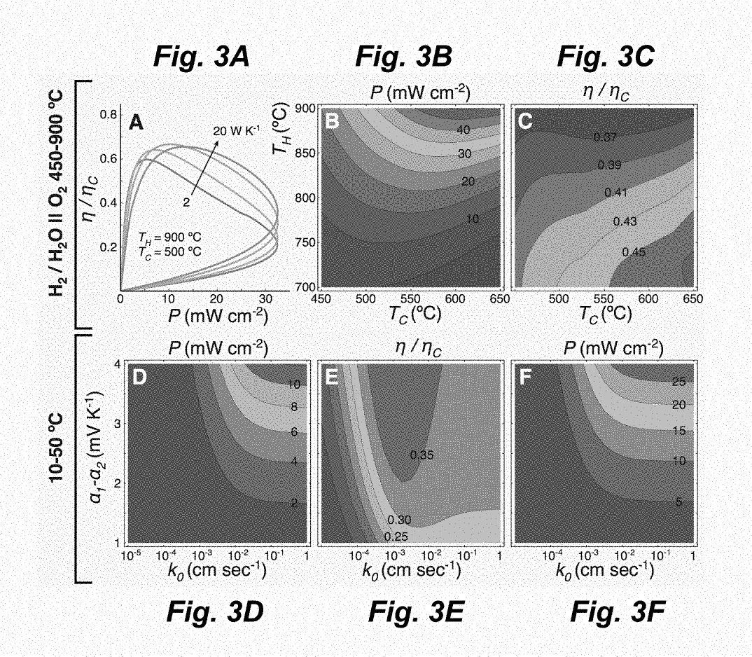

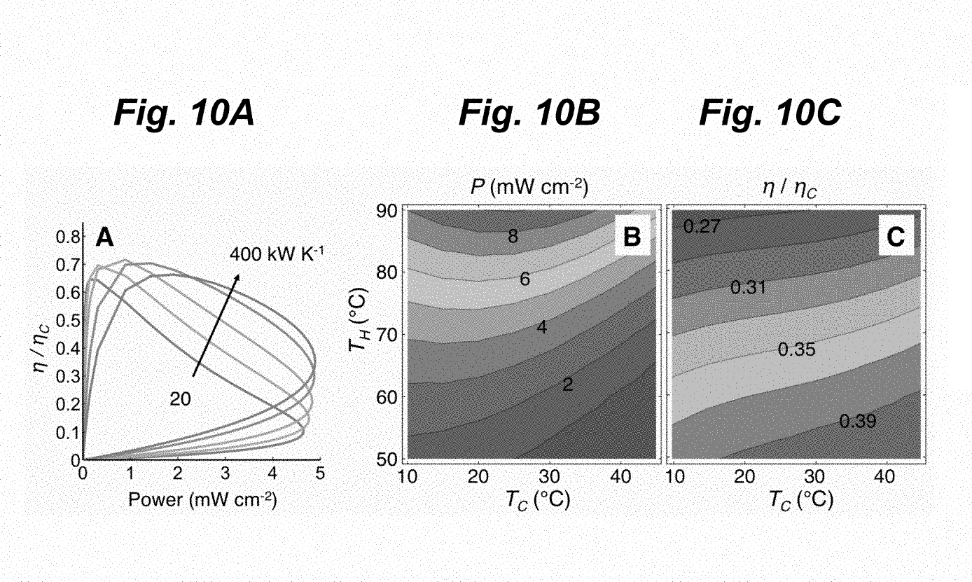

FIG. 3A shows the efficiency versus output power density per unit area of membrane for a gas-phase electrochemical heat engine using oxygen gas as the entropy carrier operating between 900° C. and 500° C. using 90% H₂O and 10% H₂ versus 21% O₂. The four curves correspond to a counterflow heat exchanger rated for 2, 5, 10, and 20 W K⁻¹ at 700° C. between the hot and cold cell stacks. Increasing the overall thermal conductance by a factor of ten does not noticeably affect the maximum power, but improves the efficiency at maximum power point from 0.154 η_{c} to 0.376 η_{c}. Similar results are obtained for the liquid-based heat engine (FIGS. 10A-C).

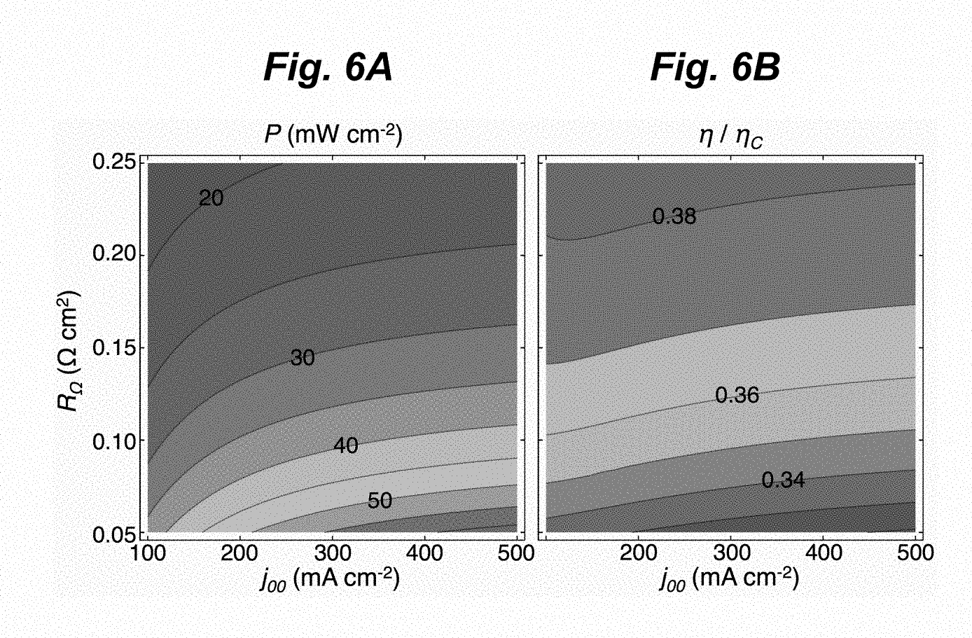

FIG. 3B simulates the maximum output power per membrane area, and FIG. 3C simulates the efficiency at maximum power point as a function of T_{H} and T_{C} for a continuous electrochemical heat engine with the heat exchanger rated for 20 W K⁻¹. In this simulation, output power densities over 40 mW cm⁻² are possible, with efficiencies over 0.35η_{c} at the maximum power point. Similar to our experimental demonstration in FIG. 2F, for fixed T_{H} and low T_{C} the power density is limited by the resistance of the low-temperature cells. These results indicate that improvements to the cell resistance (e.g., improved ionic transport or electrocatalysts) increase the power density and extend the operable temperature range of the engine (FIGS. 6A-B). Simulations corresponding to panels FIGS. 3A-C for the liquid-based system are shown in FIG. 10.

Maximum power density is shown in FIG. 3D and efficiency is shown in FIG. 3E at the maximum power point for a liquid-based heat engine operating between 50° C. and 10° C. as a function of total α and k₀, with concentrations of active species corresponding to the system shown in FIGS. 2A-C. Corresponding simulations for the gas-based system are shown in FIGS. 6A-B. FIG. 3F shows maximum power density for the same liquid-based electrochemical heat engine, with 15M concentrations of active species.

An analysis of a generalized liquid-phase heat engine also points to two distinct operating regimes. For active species concentrations and temperatures corresponding to those in FIGS. 2A-F, the maximum power increases with the electrode reaction rate constant k₀ until k₀=0.05 cm sec⁻¹ (FIG. 3D). At higher values of k₀, the power output is only a function of thermopower α. In this regime, the current-dependent polarization resistance for the surface reactions is smaller than the combined ohmic resistance of the cell membrane and mass transport losses in solution. Since the electrochemical heat engine has four active interfaces, this result shows that a regime exists in which interfacial kinetics do not limit the performance of the system, despite the additional interfaces we introduce. FIG. 3E shows that efficiencies over 30% of η_{c} at the maximum power point are achievable for a wide range of electrochemical redox couples. As seen in a variety of other electrochemical systems, the simulation also suggests that mass transport limits the maximum obtainable power density; more efficient fluid flow patterns, and increased active species concentrations will both lead to higher power densities. FIG. 3F simulates the latter case, in which a more concentrated redox fluid is used (15 M, corresponding to pure substances or slurries), enabling power densities over 20 mW cm⁻².

Our modeling shows that the doubled number of interfaces relative to TE and TG systems does not necessarily limit performance, as the added irreversibility is compensated by the increased thermopower and counterflow heat exchange. Furthermore, the ability to form stacks of cells in series at each temperature to increase voltage without the coupling to heat losses is fundamentally different from that in TE systems: it enables further minimization of heat leaks while independently optimizing the electrical performance. Even after accounting for practical losses in a simple device configuration, the continuous electrochemical heat engine can scalably reach maximum power point efficiencies well over 30% of η_{c} under diverse operating conditions. It is also worth noting that stacks of multiple electrodes can achieve much higher areal power densities than individual cells. For example, with 100 cells per stack (the geometry simulated in FIG. 3), the device-level areal power density is 4 W cm⁻², a quantity that is more comparable with the areal power densities generally reported for TE devices.

By decoupling thermal and electrical entropy generation pathways, the principles of the present invention enable effective energy conversion in regimes heretofore inaccessible to thermoelectric, thermogalvanic, regenerative, or other thermal-fluid heat engines. While electricity generation is described in this work, operating these systems in reverse could in principle enable electrochemical refrigeration as well. In addition to the significant flexibility in size and form, a vast parameter space exists for the optimization of working fluids: redox transformations of pure substances, ion-transporting liquids, and gas-phase reactants could all be used. With the development of suitable redox chemistries and flow systems, continuous electrochemical heat engines could fill a vital missing space in the existing landscape of energy harvesting technologies.

The V^{2+/3+}∥Fe(CN)₆^{3-/4-} energy harvester was tested under constant N2 purge in both electrode compartments. The negative electrode was fabricated using carbon cloth (ELAT hydrophilic, 400 μm thickness), heat treated in air at 400° C. for 30 hrs prior to the experiment to functionalize the electrode surface, as described previously. The positive electrode was fabricated with a 0.5 mg/cm² Pt loading on carbon paper (Spectracarb 2050a, 252 μm thickness), as described above. The thicker (127 μm) Nafion membrane was to prevent crossover between the vanadium and ferrocyanide electrolytes. Prior to testing both electrode compartments were filled with 3MVOSO₄ (Aldrich) in 6M HCl (Aldrich) in degassed water, 1 mL in the negative electrode compartment and 3 mL in the positive electrode compartment. A potential of 1.4V was then applied across the cell until 430 coulombs of charge had passed through the cell, such that the negative electrode compartment then contained a 1:1 mixture of V²⁺ and V³⁺, and the positive electrode compartment contained a 1:1 mixture of V⁴⁺ and V⁵⁺ species. The positive electrode compartment was emptied with a syringe, rinsed with degassed water, and re-filled with 375 mM K₄Fe(CN)₆ and 375 mM K₄Fe(CN)₆ in degassed pH 7.2 phosphate buffer prior to testing. The positive electrode compartment was covered in aluminum foil due to the known sensitivity of ferrocyanide compounds to light. The vanadium compartment was left open to monitor the blue-green-purple color change that confirms a successful reduction procedure.

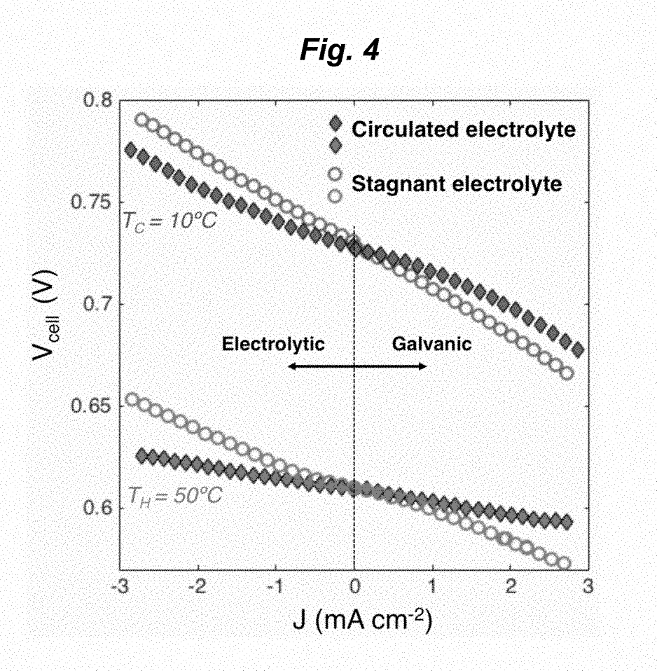

In a scaled-up energy harvesting system, the circulation of electrolyte may result in a reduction of mass-transfer related overpotential, and correspondingly more favorable polarization behavior is expected. To gain insight into to the magnitude of the improvement that could be realized with fast flow outside of the membrane-electrode assembly, peristaltic pumps (ZJchao, 12V) were used to provide jet-impingement mass transfer enhancement inside both working fluid chambers. The improvement in mass transfer behavior is shown in FIG. 4.

### Gas Phase Demonstration

We used anode-supported solid-oxide button fuel cells available commercially from Fuel Cell Materials (ASC2.0) and used without modification. The cells with membranes 500, 502 were sealed with molten Ag at approximately 920° C. in two Probostat testing rigs (Norwegian Electroceramics) shown in FIG. 5. Each seal was monitored to yield no detectable leaks in a downstream bubbler at an overpressure of 2 cm of water for at least 5 minutes. The active area of each cell is 1.10 cm².

We controlled for microscopic gas leaks across the fuel cells by ensuring they have the same open-circuit potentials at the same temperatures. Measured open-circuit potentials were within 10 mV of the Nernstian limit. Over the course of the two-day experiment, we adjusted T_{H} down as the open-circuit potential degraded by ˜3 mV to avoid artificially inflating the voltage and power density of the system. This resulted in a slight underestimation of the power density of the system.

The gas compositions supplied to the system were 5% H₂ balance Ar, humidified at a room temperature of 18° C., versus dry 21% O₂ in Ar, both at flow rates of approximately 80 sccm as measured by mass flow controllers (MKS) calibrated with Ar.

The J-V curve in FIG. 2 was taken with a BioLogic SP-240 potentiostat in a 4-electrode configuration as a series of galvanostatic steps. In each step, the current was allowed to stabilize over 5 seconds, enough to reach a consistent steady-state value.

### Continuous Liquid-Phase Energy Harvesting System, and the Calculation of Energy Conversion Efficiency as η=0.61 η_{c}.

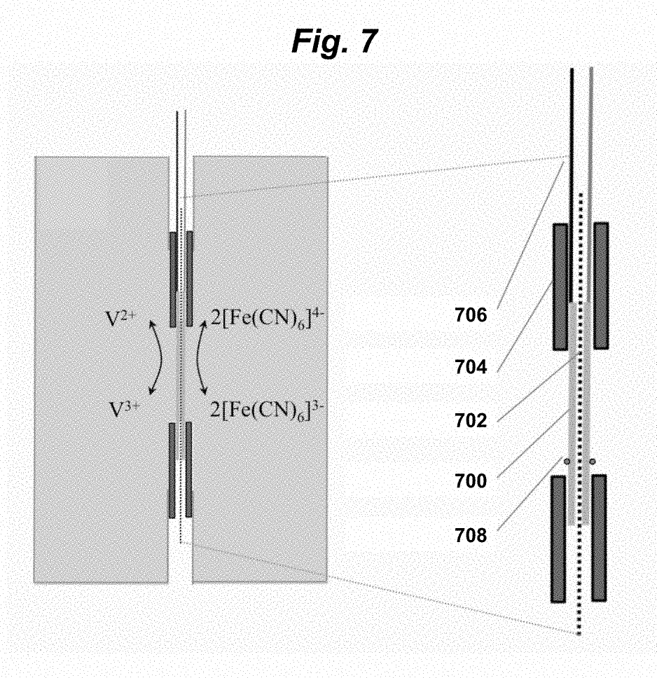

In one embodiment of the invention, V^{2+/3+}∥Fe(CN)₆^{3-/4-} liquid flow cells were constructed as shown in FIG. 7. Positive electrodes 700 were made from carbon cloth (ELAT hydrophilic, 400 μm thickness) that was first functionalized by burning in air for 30s using a butane torch. A Pt—C catalyst ink consisting of 50 μg/μL HISPEC 40% Pt on high surface area carbon in 3:2:0.1 H₂O (MilliQ Synergy UV):Isopropanol (Aldrich):Nafion 117 dispersion (Aldrich) was dropcast onto the positive electrodes for a total Pt loading of 0.5 mg/cm². Negative electrodes were made from carbon paper (Spectracarb 2050a, 252 μm thickness) functionalized by burning in air for 30s using a butane torch. Electrode contacts were made with strips of Ti foil (GalliumSource, Grade II, 12.5 μm thickness). Anolyte and catholyte flows were separated by a Nafion 212 membrane 702 (FuelCellStore, 51 μm thickness). The membrane-electrode assembly was compressed into a machined acrylic housing, and sealed using silicone rubber gasket sheeting 704 (McMaster-Carr, 500 μm in the negative electrode compartment, 1250 μm in the positive electrode compartment). A channel cut into each gasket sheet (1 cm×10 cm) defined the flow path through each cell. Also includes were leads 706 and thermocouples 708.

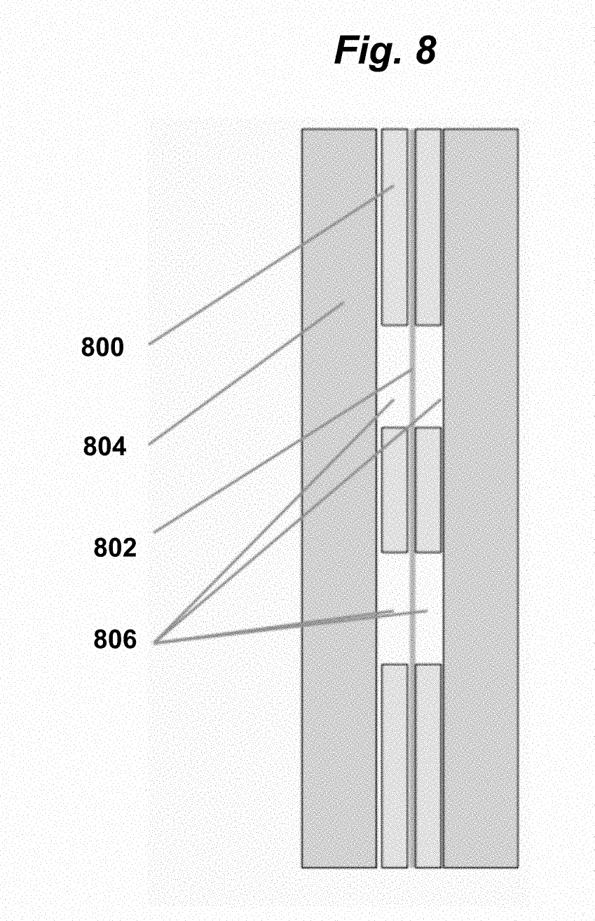

A counterflow heat exchanger was constructed in a similar manner to the two flow cells, as shown in FIG. 8. Two channels were cut in two separate silicone rubber gaskets 800 (McMaster Carr, 120 μm thickness). A strip of Ti foil 802 (GalliumSource, Grade II, 12.5 μm thickness) was placed between the two gaskets, and the foil-gasket assembly was compressed between machined acrylic sheets 804, forming a 2-channel counterflow heat exchanger with fluid channels 806. In the energy harvesting system, the Fe(CN)₆^{3-/4-} electrolyte was run in one channel, and the V^{2+/3+} electrolyte in another. This allowed matching of the flow rate and heat capacity of the hot-to-cold and cold-to-hot streams in each channel, so that a heat exchange effectiveness of 1 corresponded to a heat exchange efficiency of 100%. This poor performance at low flow rates is likely due to the balance between the exchanged heat flux and the heat loss to the ambient, which increases with the increasing residence time in the heat exchanger at low flow rates. At the low flow rates, the effective conductance of the flow of liquid of heat capacity cₚ was relatively smaller than that due the convective loss to the ambient for the heat exchanger outer surface area A and convective heat transfer coefficient h. To mitigate this loss, future energy harvesting systems for which hA>(\dot{m}cₚ) should be sealed and tested under low vacuum conditions.

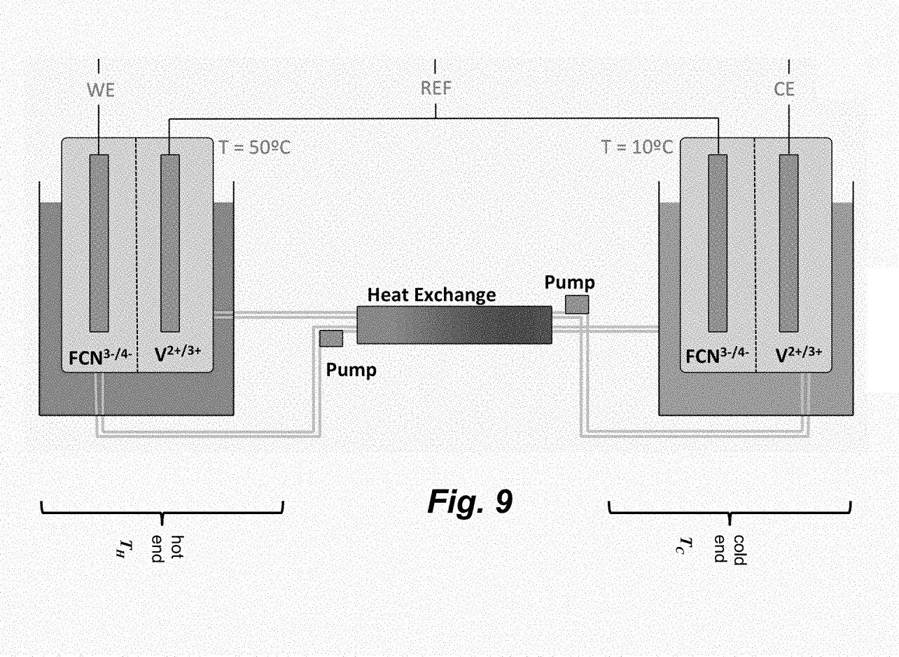

All energy harvesting experiments were conducted in a N₂-purged glove box (MTI VGB-4 with Instru-Tech Stinger pressure regulator, MTI O₂ sensor and no H₂O regulation). For these experiments, two of the liquid flow cells were connected in a single fluidic circuit as shown in FIG. 9. Two peristaltic pumps (Masterflex 77120-32) were driven at a low duty cycle as required to match the flow rate to the reaction rate. The flow rates at these pumps were calibrated prior to the tests by measuring the time required to fill a graduated cylinder. The flow rate of the Fe(CN)₆^{3-/4-} electrolyte was 4× that of the V^{2+/3+} electrolyte to compensate for the difference in charge capacity between the two solutions. One cell was placed in a chilled bath (Boekel Microcooler II, Model 260010) and the other in a temperature-controller water bath (Fisher Scientific 11-400-495HP). The cells were connected in series and electrical measurements were performed via galvanostatic techniques (Biologic SP-240, Current Scan technique). Temperature was monitored at both the hot and cold cells, and in at both liquid inputs to the hot cell using type thermocouples (Omega type T) that were welded with junction sizes <200 μm (Omega TL-Weld) and coated with poly methacrylate (PMMA, Aldrich) cast from a acetone/toluene solution (Aldrich). This provided a very thin chemically-resistant coating that allowed the thermocouples to function despite the harsh chemical environment of the electrolyte. Temperature signals were collected using an analog signal processing unit (Agilent 34972A). Prior to use, the system comprising the peristaltic pumps, heat exchangers, and two flow cells was filled with the two electrolyte solutions. One solution contained 375 mM Potassium Hexacyanoferrate (II) (Aldrich) and 375 mM Potassium Ferricyanide (III) (Aldrich) in pH 7.2 phosphate buffer (Aldrich 94951) diluted 10:2 with deionized water (MilliQ Synergy UV). The other electrolyte was obtained by reduction of a solution containing 3M VOSO4 (Aldrich) in 6M HCl (Aldrich) for ˜40 hrs in a vigorously stirred cell identical to that used for the d V_{OC}/dT measurements. An excess volume of 2M VOSO4 (Aldrich) in 6M HCl (Aldrich) was oxidized at the counter electrode and discarded after use. The tubing of the energy harvesting system was disconnected directly upstream of the two peristaltic pumps, and the two electrolytes were slowly injected at the same time with two syringes as the pumps were run without the peristaltic rollers fully engaged. Both cells were oriented with inlets down during this process. Once the electrolyte volume was filled and electrolyte began to leak out of the disconnected tubing, the tubing was connected and the peristaltic rollers engaged. Extreme care had to be exercised when filling the system with the syringes, as excessive pressure in one syringe would rupture the membrane-electrode assembly separating the two electrolyte compartments in the upstream cell.

The effective power input to the energy harvesting system was estimated adding the thermodynamic heat input required by the electrode process I*T_{H} (α₁-α₂) to the sensible heat leaked through the heat exchanger. This sensible heat leak was estimated by measuring the temperature increase of the electrolyte solutions as they traveled from the hot to cold cell, and multiplying the temperature increase ΔT of both solutions from the cold cell by the mass flow rate m and heat capacity cₚ of each electrolyte solution. Ideally, the power input into the system would be calculated as Pᵢₙ=I*T_{H} (α₁-α₂)+[(\dot{m} cₚ)_{FCN(II/III)}+(\dot{m}cₚ)_{V(II/III)}] (T_{Hot}−T_{Inlet}), where T_{Inlet} is the measured temperature of both electrolyte solutions between the exits from the hot side of the heat exchanger and the inlets of the hot cell. However, temperature measurements at different points in the flow system indicated that the electrolyte circulation was slow enough that the electrolyte emerging from the cold cell nearly equilibrated with the glove box environmental temperature (˜28° C.) before entering the heat exchanger. Since this heat transfer from the environment constituted an additional energy input, it was considered improper to measure the energy input in this way. As a result, for the purposes of the efficiency calculation, the energy input was calculated conservatively as (I*V_{OC})+[(\dot{m} cₚ)_{FCN(II/III)}+(\dot{m} cₚ)_{V(II/III)}] (T_{Hot}−T_{Cold}). This energy input is much less than the total energy input from the heater, as the heat leaks through the cell leads and other heat loss to the environment. However, since it is equivalent to the energy input required in the complete absence of the heat exchanger, it is likely an upper bound on the energy input that would be required in a scaled up, insulated system. The cₚ and density ρ values of both electrolytes were measured as described in the next section. The mass flow rate \dot{m} was based on the measured densities ρ and the volumetric flow rates Q through the pumps, which had previously been calibrated using a graduated cylinder.

The power output from the energy harvesting system was obtained by measuring the system's current-voltage curve with a potentiostat (Biologic SP-240). The resistance of the long (>2 m) leads and contacts between the energy harvesting system inside the glove box and the potentiostat in the laboratory was measured between 1 and 1.5Ω, but this resistance was not compensated in the electrical measurement or the reported polarization curves because it varied slightly each time the leads were connected to the cell. The efficiency of energy conversion η was then calculated as:

$$\begin{matrix}η = \frac{Power output}{Power input} = \frac{Power \text{output}}{Thermodynamic heat input + heat leak} = \\ = ( \frac{I * V}{\begin{matrix}I * {T}_{Hot} ( {α}_{1} - {α}_{2} ) + \\ ( {Q}_{FCN} {c}_{p , FCN} {ρ}_{FCN} + {Q}_{V} {c}_{p , V} {ρ}_{V} ) ( {T}_{Hot} - {T}_{Cold} )\end{matrix}} )\end{matrix} \qquad ( 1.2 )$$

Here the subscript V denotes the V^{2+/3+} electrolyte, and FCN denotes the Fe(CN)₆^{3-/4-} electrolyte. This yielded the reported values of η=0.042 (0.34 η_{c}) at 0.25 mA cm⁻² and η=0.018 (0.15 η_{c}) at the maximum power point of 1.8 mA cm⁻².

These efficiency values do not include the impact of the heat exchanger, out of consideration for the leak of heat into the system from the ambient discussed above. However, it is interesting to project the efficiency of a scaled-up system, in which the flow rate of electrolyte could be increased such that the heat loss to the ambient due to long residence times in the heat exchanger could be minimized. In this case, the effective efficiency of the energy harvesting system could be estimated as:

$$η = ( \frac{( I * V )}{\begin{matrix}I * {T}_{Hot} ( {α}_{1} - {α}_{2} ) + \\ ( {Q}_{FCN} {c}_{p , FCN} {ρ}_{FCN} ( 1 - {ɛ}_{HX} ( {Q}_{FCN} ) ) + \\ {Q}_{V} {c}_{p , V} {ρ}_{V} ( 1 - {ɛ}_{HX} ( {Q}_{V} ) ) ) ( {T}_{Hot} - {T}_{Cold} )\end{matrix}} )$$

Here ε_{HX} (Q) denotes the efficiency of the heat exchanger as a function of flow rate Q, which is equivalent to the heat exchanger effectiveness in this case because the \dot{m} cₚ are matched in both electrolyte streams. For example, based on the performance of the heat exchanger given in Extended Data FIG. 6c, if the electrode area of both cells was increased by 1000×, such that flow rates reached ˜1 mL/min for the V^{2+/3+} and ˜4 mL/min for the Fe(CN)₆^{3-/4-} electrolytes, this yields and η=0.076 (0.61 η_{c}) at 0.5 mA cm⁻². While this efficiency estimate neglects heat losses to the environment, heat losses through power leads, and pumping power, and is therefore less realistic than the projected power and efficiency metrics in the main text, it is informative to compare this efficiency with that used by previous authors. For example, Lee et al. 5 use the same approach to report a system efficiency of η=0.067 for a Thermally Regenerative Electrochemical Cycle (TREC). However, it's worth noting that the purely presumed heat exchange efficiency of 50% in that work would require a multi-step regenerative process, rather than the simple counterflow heat exchange implemented here, since liquid counterflow heat exchange is not practicable for TREC systems using solid battery materials.

### System Modeling and Simulation

### List of Symbols, in Order of Appearance

| | |
|---|---|
| c_{O}, c_{R} | Concentrations of reduced and oxidized active species |
| η_{act} | Activation overpotential |
| R_{Ω}, R_{Lead} | Ohmic resistance of electrochemical cell and solution, |
| | leads |
| V_{OC} | Open-circuit voltage for the heat engine |
| I, J, V, A | Current, current density, voltage, active cell area |
| E, E⁰ | Cell potential, standard potential |
| α | Seebeck coefficient, temperature change in cell voltage |
| E_{act} | Activation energy |
| k₀ | Reaction rate constant |
| j₀₀ | Exchange current density |
| h_{c}, L_{c}, w_{c} | Height, length, and width of cell chambers |
| γ | Dimensionless measure of mass transport |
| Pe, Re, Pr, Nu | Peclet, Reynolds, Prandtl, and Nusselt numbers |
| κᵢ | Heat conductivity of species i |
| μᵢ | Dynamic viscosity (η in some texts) of species i |
| pᵢ | Partial pressure of species i |
| MW, BP | Molar weight, boiling point |
| cₚ, ρ | Heat capacity, density |
| r, rᵢ, rₒ, rₜ | Radius (general, of a tube, inner or outer tubes, etc) |
| νₗᵢₙ, νᵥₒₗ | Linear and volumetric flow velocities |
| L_{HX}, L_{ER}, t | HX length, entrance region length, tube wall thickness |
| h, hᵢ, hₒ | Convective heat transfer coeff. (inner/outer chamber) |
| R_{wall}, R_{F} | Heat resistances: wall and fouling |
| ε_{HX}, εₚᵤₘₚ | Effectiveness of the heat exchanger, pump efficiency |
| P, ΔPᵢ | Head pressures in the heat exchanger and cells |
| T_{H}, T_{C}, ΔT | Hot cell T, cold cell T, temperature drop across the |
| | engine |
| Pₚᵤₘₚ | Pump power |
| P_{system}, P_{lead} | Total power output, power dissipated in leads |
| \dot{Q} | Heat leaks in various parts of the system |
| ρ_{L} | Resistivity of the lead material |
| N, N_{cells} | Number of heat exchanger tubes, number of cells in a |
| | stack |

### Electronic Operation of One Cell

The open-circuit voltage of the system is V_{OC}=(α₁-α₂)(T_{H}−T_{C})=αΔT

Voltage is solved as a function of current density: V(I)=V(local c_{O}, c_{R})−2η_{act}−IR_{Ω}

Here R_{Ω} is the Ohmic resistance of both the cell and the solution together. The voltage is added in series for the cells in the stack. The open-circuit potential for one cell was taken as Nernstian, including concentration terms, and a temperature-dependent reference potential:

$$E = \frac{RT}{nF} ln ( \frac{{c}_{O}^{2}}{{c}_{R}^{2}} ) + {E}^{0} + α ( T - 298.15 )$$

For the heat engine operating with two cells using the same redox couples, the non-equilibrium Nernst voltage simplifies to

$$V = {E}_{C} - {E}_{H} = {V}_{OC} + \frac{{RT}_{C}}{nF} ln ( \frac{{c}_{O , cold , local}^{2}}{{c}_{R , cold , local}^{2}} ) - \frac{{RT}_{H}}{nF} ln ( \frac{{c}_{O , hot , local}^{2}}{{c}_{R , hot , local}^{2}} )$$

Here, concentrations are squared to account for the two concentration ratios on the two sides of the membrane, and referenced to 1M. The symmetric nature of each cell, and only equal concentrations considered, warrant this simplification. The total temperature coefficient α of the system was used as a parameter. Notably, as the current density approaches the mass transport limit, the concentration term becomes large, and dominates the resulting voltage loss.

Activation overpotential is given by the Butler-Volmer equation:

$${η}_{act} ( J ) = \frac{RT}{0.5 nF} {sinh}^{- 1} ( \frac{J}{2 {k}_{0} {c}_{O}^{0.5} {c}_{R}^{0.5} exp ( - \frac{{E}_{act}}{R} ( \frac{1}{T} - \frac{1}{{T}_{ref}} ) )} )$$

For the liquid cell, we used a symmetry factor of 0.5, activation energy of 50 kJ/mol, and referenced the values of k₀ to 1M concentrations at 273 K. Notably, the concentrations used are local at the electrode. The activation overpotential diverges as the current density approaches the limiting current density, and one of the concentrations approaches zero. For the gas cell, the exchange current density formalism was used, with reference values given below.

Ohmic resistance was taken as ⅓ of resistance values for 1M HBr, 6 and Nafion resistance 7 was used for a membrane of thickness 25 microns, independent of temperature. The thickness of the acid solution was taken as the minimum of hc and 0.15 mm. The conductivity of an acid solution was modeled to increase with temperature as diffusion is enhanced with decreasing viscosity of the fluid.

### Local Concentration and Mass Transport

In calculating the local concentrations, a plug flow was assumed in the cell. The limiting current is given analytically with a Taylor series solution. The dimensionless measure of mass transport giving the maximum reagent utilization is calculated as:

$$γ = \frac{2}{{h}_{c} Pe} {\int }_{0}^{{L}_{c}} ( {\sum }_{n = 0}^{terms} exp ( - {( n + 0.5 )}^{2} {π}^{2} \frac{t}{h Pe} ) ) dt$$

Note that the Peclet number varies with temperature for a constant volumetric flow rate, due to the temperature enhancement of diffusion. The factor γ was calculated individually for the hot and cold cells. The Taylor series was evaluated to 30 terms, giving a compromise between underestimating the limiting current density and computational complexity.

Limiting current was calculated from the total inlet flux and the factor γ:

Jₗᵢₘ=γh_{c}w_{c}c_{O,R,inlet}F

The local concentrations at the electrodes are given as

$${C}_{O , R , local} = {C}_{O , R , inlet} ( 1 \pm \frac{J}{{J}_{lim}} )$$

depending on whether the species is consumed or produced at the electrodes. As the current density approaches the calculated limit, one of the local concentrations becomes fully depleted (even though the flow of the reagents to the cell may not be completely consumed). This affects both the Nernstian potential term, and the activation overpotential.

For connecting two cells in series, outlet reagent fluxes are calculated trivially at the first cell (hot cell in this simulation), and are used as inlet fluxes for the other cell. Since the cells are always current-matched and operating in reverse of each other, the inlet fluxes to the first cell are recovered from the outlet fluxes of the second. This assumes complete mixing of the electrolyte in between the cells, so that the concentrations of active species at the inlets of all cells are homogeneous.

### System Hydrodynamics

The heat conductivity, specific heat, and dynamic viscosity for the solution in the liquid cells were assumed identical to water and taken from tables for liquid water at atmospheric pressure. For gases, respective temperature-dependent values were taken for O₂, H₂O, and H₂.

For binary mixtures of gases, e.g. H₂ and H₂O, the specific heat and density were taken as linear combinations of the respective constituent values, while the heat conductivity and viscosity were recalculated 13,14 for the mixtures. For gases, the partial pressures were used as proxies for the composition fractions (x₁, x₂).

Laminar flow regime was used for the majority of calculations, and the assumption verified by checking the Reynolds number. The heat exchanger was assumed to have a counter-flow configuration with straight concentric circular pipes. Dimensionless quantities were calculated at the mean temperature between hot and cold cells for each working fluid in a circular pipe:

$$Re = \frac{ρ {v}_{lin} 2 r}{μ} \cdot \frac{π {r}^{2}}{π {r}^{2}} = \frac{2 ρ {v}_{vol}}{μπ r} , Pr = \frac{μ {c}_{p}}{κ}$$

The average Nusselt numbers were calculated separately for the thermal entrance region and fully developed flows under the assumption of laminar flow. The length of the entrance region for establishing laminar flow is given as LER=0.06×Re×2 r. The Nusselt number was calculated for the entrance region using the Sieder and Tate correlation 15 modifying the traditional Graetz solution, neglecting the temperature dependence of viscosity:

$${Nu}_{ER} = 1.86 \sqrt[3]{\frac{2 r Re Pr}{{L}_{ER}}}$$

The length LER varied widely and was in general not negligible compared to the simulated heat exchanger lengths (0.5-10 m). The Nusselt number for the fully developed laminar flow regions outside of the entrance lengths was taken as 48/11.

The convective heat transfer coefficient was calculated as h=κNu. This is equivalent to making 2 r the assumption that the convective “depletion” width is comparable to the radius of the pipe, which is reasonable for long pipes.

### Heat Exchanger and Pump Work

The heat exchanger is modeled as a counter-flow heat exchanger. The thermal resistance of the heat exchanger wall is given analytically:

$${R}_{wall} = \frac{ln ( \frac{r + t}{r} )}{2 {πκ}_{wall} {L}_{HX}}$$

In general, the heat conductivity of the exchanger is given as:

$$UA = \frac{N}{\begin{matrix}\frac{1}{2 π {r}_{i} {L}_{HX} {h}_{i}} + \frac{{R}_{F , i}}{2 π {r}_{i} {L}_{HX}} + {R}_{wall} + \\ \frac{{R}_{F , o}}{2 π ( {r}_{i} + t ) {L}_{HX}} + \frac{1}{2 π ( {r}_{i} + t ) {L}_{HX} {h}_{o}}\end{matrix}}$$

The five terms in the denominator correspond to heat transfer across the fluid layers, the fouling resistances, and across the pipe wall in each heat exchanger. UA was first taken as an input parameter, together with N, ri, and t, for the particular temperature and working fluids of the simulation. Assuming fully developed flows, LHX was calculated. UA was then re-calculated, accounting for entrance regions in the heat exchanger. For example, if the two entrance lengths were calculated to be 10% of LHX each, then the final UA was comprised of 80% the input value for fully developed flows, and 20% using equation (2.5) with one of the coefficients h re-calculated as above for an entrance region. When varying the input UA value parametrically, the parameter N was varied conjointly, so the total length LHX remained constant (FIG. 3A, FIG. S14).

In the number of thermal units formalism, the heat exchanger efficiency is given as:

$${ɛ}_{HX} = \frac{\frac{UA}{\dot{m} {c}_{p}}}{1 + \frac{UA}{\dot{m} {c}_{p}}}$$

This expression is simplified for the constraint of matching heat flows in the two pipes of the heat exchanger, which was enforced in simulations. The conductive heat leak along the cross-sectional area of the walls of each of 2N heat exchanger tubes in the system is given as:

$$\dot{Q} = \frac{{κ}_{wall} Δ T}{{L}_{HX}} π ( {( {r}_{i} + t )}^{2} + {( {r}_{o} + t )}^{2} - {r}_{i}^{2} - {r}_{o}^{2} )$$

The head pressure in each annular tube is given analytically as:

$$Δ {P}_{HX} = \frac{8 {v}_{vol} μ {L}_{HX}}{π ( {r}_{o}^{2} - {r}_{i}^{2} ) ( {r}_{o}^{2} + {r}_{i}^{2} - \frac{{r}_{o}^{2} - {r}_{i}^{2}}{ln ( {r}_{o} \text{/} {r}_{i} )} )}$$

The head pressure in each cell chamber is

$$Δ {P}_{cell} = \frac{3 {v}_{vol} μ {L}_{c} {w}_{c}}{2 {h}_{c}}$$

The head pressure scales directly with the total area of cells, and independent of the number of cells in a stack of a given total area. Overpressures built up in the pipe junctions and bends were ignored. Note that the flow rate vvol in each tube or cell depends inversely on number of identical heat exchanger tubes N. Since fluid utilization rates were never close to unity at maximum power points, the performance of one heat exchanger was calculated, and then the result was doubled for the system. The total head pressure to be pumped is given as:

P_{head}=2(ΔP_{HX,i}+ΔP_{HX,o}+2ΔP_{cell})

### Heat Engine Efficiency

For the liquid cell, the pumping was assumed to be mechanical:

$${P}_{pump} = \frac{1}{{ɛ}_{pump}} {v}_{vol} {P}_{head}$$

For the gas cell, pumping was assumed to be electrical at 20% efficiency:

$${P}_{pump} = \frac{ρ {RTv}_{vol}}{{ɛ}_{pump} MW} ln ( \frac{{P}_{head} + P}{P} )$$

The operating pressure of the cells was taken as 1 atm. The density was calculated from STP values via the ideal gas law at the midpoint temperature of the system. The power dissipated to the resistance of the electrical leads is given as:

$${P}_{lead} = {I}^{2} {R}_{lead} = \frac{2 {ρ}_{L} {{L}_{HX} ( \frac{I}{{N}_{cells}} )}^{2}}{π {r}_{lead}^{2}}$$

This term is the main origin of the scaling behavior of the system upon stacking. The resistance of mechanical components holding the stack together (i.e. bipolar plates) is ignored.

The power output of the system is

P_{system}=IV−P_{lead}−Pₚᵤₘₚ

The reversible entropy change for the electrochemical reaction at the hot side is:

ΔS=ΣS_{prod}−ΣS_{react}

This has two components: the configurational concentration term, equivalent to the Nernstian concentration ratio, and the thermodynamic term. In the case of the liquid cell, the thermodynamic term is the total effective Seebeck coefficient α divided by the electron charge q.

Phenomenologically, the heat input to the system is given as for a thermoelectric with a heat exchanger:

\dot{Q}=αIT+2\dot{Q}_{HX}+(1−ε_{HX})(\dot{m}cₚ)ₜₒₜₐₗΔT−0.5P_{lead}

The efficiency of the system is

$${η}_{system} = \frac{{P}_{system}}{\dot{Q}}$$

equivalent to equation (1) in the main text.

### Maximum Power Point

For each set of design parameters (heat exchanger size, cell dimensions, stack size), and materials parameters (ohmic resistances, exchange current densities), the current density was swept to find the maximum power density. For the liquid system, the circulation flow rate was also left free during the optimization via the Pe number.

Constants and Parameters—Gas Cells

Total area 1 m², 100 cells, each 10 cm long and 10 cm wide, with chamber height 1 cm. For the redox couples, a mixture of 10% H₂ and 90% H₂Oversus 21% O₂ were used, for a thermopower of −0.42 mV/K. Using this mixture of gases in our experiment would have increased the power densities in FIG. 2(F) by a factor of 1.93.

Electrolyte ohmic resistance: modeled as doped ceria with area-specific resistance (ASR) 0.1 Ωcm² at 500° C., and activation energy 57 kJ/mol. Additionally, a 100 nm layer of YSZ was modeled.

Activation overpotentials: hot cell at T_{H} with j₀₀=500 mA cm⁻² at 700° C. and activation energy 100 kJ/mol for the cathode and the anode. For the cold cell at T_{C}, j₀₀=150 mA cm⁻² at 500° C., and activation energy 96.65 kJ/mol. Reference pressures pH₂=0.97 atm, pH₂O=0.03 atm, and pO₂=0.21 atm were used, with unity pressure dependences for the anode, and square-root pressure dependences for the cathode.

Heat exchangers were modeled with silica heat conductivity, number of tubes N=50, each with wall thickness 2 mm, inner radius 2 cm, and outer radius 4 cm, and conductivity for fully developed flows UA=20 W K⁻¹. Leads were modeled as molybdenum, radius 1 cm, and with the same length as the heat exchanger.

### Constants and Parameters—Liquid Cells

Total area 1 m², 100 cells, each 10 cm long and 10 cm wide, with chamber height 0.2 mm. All thermohydraulic parameters were taken as for liquid water. The diffusion coefficient of active species in the fluid at room temperature was taken as D=10⁻⁵ cm² sec⁻¹. Heat exchangers were modeled with titanium heat conductivity, conductivity for fully developed flows UA=400 kW K⁻¹, wall thickness 0.25 mm, inner radius 0.25 cm, and outer radius 0.5 cm, with a number of tubes N=10000. Leads were modeled as molybdenum, with cross-section area 50 mm2, and with the same length as the heat exchanger.

1. A device for direct thermoelectrochemical heat-to-electricity conversion, the device comprising:
a first electrochemical cell comprising a first gas-impermeable, electron-blocking membrane capable of transporting an ion I at a first temperature, and a first pair of electrodes on opposite sides of the first membrane,
a second electrochemical cell comprising a second gas-impermeable, electron-blocking membrane capable of transporting the ion I at a second temperature lower than the first temperature, and a second pair of electrodes on opposite sides of the second membrane,
a closed-circuit chamber A comprising a working fluid A, a pump A, and a counter-flow heat exchanger A, wherein the closed-circuit chamber A is connected to the first electrochemical cell on a side A of the first membrane and to the second electrochemical cell on a side A of the second membrane,
a closed-circuit chamber B comprising a working fluid B, a pump B, and a counter-flow heat exchanger B, wherein the closed-circuit chamber B is connected to the first electrochemical cell on a side B of the first membrane and to the second electrochemical cell on a side B of the second membrane,
wherein working fluid A is capable of undergoing a reversible redox half-reaction of the general form R_{A}→O_{A}+I+e⁻ and wherein working fluid B is capable of undergoing a reversible redox half-reaction of the general form R_{B}→O_{B}+I+e⁻, where R_{A} and R_{B} are reduced forms of active species in working fluid A and working fluid B, respectively, O_{A} and O_{B} are the oxidized forms of active species in working fluid A and working fluid B, respectively,
wherein the first electrochemical cell is connected electrically in series with the second electrochemical cell,
wherein one of the first pair of electrodes is porous to the working fluid A, and another one of the first pair of electrodes is porous to the working fluid B,
wherein one of the second pair of electrodes is porous to the working fluid A, and another one of the second pair of electrodes is porous to the working fluid B,
wherein one of the first pair of electrodes is electrically connected to one the second pair of electrodes via an electrical load to produce electricity,
whereby the first electrochemical cell runs a forward redox reaction, gaining entropy, and the second electrochemical cell runs a reverse redox reaction, expelling entropy.

2. The device of claim 1 wherein the first electrochemical cell comprises multiple electrochemical cells connected in series.

3. The device of claim 1 wherein the second electrochemical cell comprises multiple electrochemical cells connected in series.

4. The device of claim 1 wherein the working fluid is a liquid, gas, dissolved species or slurry, supporting redox processes with different entropies of reduction and containing a species that crosses the ion-transporting membrane as the ion I.

5. The device of claim 1 wherein the working fluid is oxygen, hydrogen, water, carbon monoxide, carbon dioxide, or mixtures thereof.

6. The device of claim 1 wherein the first membrane or second membrane is an ion-conducting ceramic, an ion-conducting polymer, or a molten salt.

7. The device of claim 1 wherein the porous electrodes are alloys of W, Mo, Ni, other metals, or ceramics supported on an electronically conducting or mixed ion-electron-conducting framework.
